(19) United States
(12) Patent Application Publication
(10) Pub. No.: US 2011/0047320 A1
(43) Pub. Date: Feb. 24, 2011

(54) SYSTEM AND METHOD FOR PERFORMING PROGRAM OPERATION ON NONVOLATILE MEMORY DEVICE

(75) Inventor: Jin Hyoung KWON, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/820,452

(22) Filed: Jun. 22, 2010

(30) Foreign Application Priority Data
Aug. 20, 2009 (KR) 10-2009-0077035

(51) Int. Cl. G06F 12/00; G06F 12/02

(52) U.S. Cl. 711/103; 711/115; 711/148; 711/E12.001; 711/E12.008

(57) ABSTRACT

A data processing system performs a data processing method by receiving and interpreting a command packet corresponding to a program operation, identifying a size of data to be programmed in the program operation, and programming the data using a buffered or un-buffered program operation based on the size of the data.

### CROSS-REFERENCE TO RELATED APPLICATIONS

This application claims priority under 35 U.S.C. §119 to Korean Patent Application No. 10-2009-0077035 filed Aug. 20, 2009, the disclosure of which is hereby incorporated by reference in its entirety.

### BACKGROUND

Embodiments of the inventive concept relate generally to electronic data storage. More particularly, embodiments of the inventive concept relate to systems and methods for performing program operations in electronic data storage devices such as nonvolatile memory devices.

Most electronic devices and systems incorporate some form of electronic data storage. Perhaps the most common form of electronic data storage is semiconductor memory.

In many systems, access to the electronic data storage presents a performance bottleneck. For instance, in a computer system, a single memory access operation can consume many cycles of a system clock, requiring the computer to delay other operations.

In systems incorporating nonvolatile memory, programming operations of the nonvolatile memory can be particularly time consuming. In fact, a program operation of a nonvolatile memory can last several times as long as other memory access operations, including read operations of the nonvolatile memory and read and write operations of volatile memories.

Due to the significant performance impact of program operations of nonvolatile memory devices, system designers are constantly seeking ways to decrease the time required to perform the program operations, as well as ways to decrease the impact of the long program times.

### SUMMARY

Selected embodiments of the inventive concept provide a method and system for processing data in different ways based on the size of the data. Some of these embodiments are capable of improving system performance.

According to an embodiment of the inventive concept, a method of operating a data processing system is provided. The data processing system comprises first and second processors and first and second memory devices. The method comprises transmitting a first command packet from the first processor to the second processor, the first command packet corresponding to a first program operation for programming a first unit of data in the second memory device. The method further comprises detecting a size of the first unit of data by inspecting the command packet and determining whether the size of the first unit of data is greater than a reference value. Upon determining that the size of the first unit of data is greater than the reference value, the method copies the first unit of data from a shared memory area of the first memory device to a dedicated memory area of the first memory device, and subsequently accesses the first unit of data in the dedicated memory area for programming in the second memory device, wherein the shared memory area is shared by the first and second processors, and the dedicated memory area is dedicated to the second processor. Upon detecting that the size of the first unit of data is not greater than the reference value, the method transfers the first unit of data from the shared memory area to the second processor for programming in the second memory device.

In certain embodiments, the method further comprises transmitting a second command packet from the first processor to the second processor, the second command packet corresponding to a second program operation for programming a second unit of data in the second memory device, and storing the second unit of data in the shared memory area of the first memory device while the first unit of data is accessed in the dedicated memory area of the first memory device by the second processor.

In certain embodiments, access to the shared memory area of the first memory device is controlled such that only one of the first and second processors can access the shared memory at a time. In certain embodiments, such access is regulated using a semaphore.

In certain embodiments, the first memory device is a volatile memory device and the second memory device is a nonvolatile memory device.

In certain embodiments, the first memory device is a dynamic random access memory and the second memory device is a flash memory device.

In certain embodiments, the first memory device is a multi-port memory device.

In certain embodiments, the second processor is an application specific integrated circuit.

In certain embodiments, the first memory device, the second memory device, and the second processor form a memory link architecture.

According to another embodiment of the inventive concept, a data processing system comprises a first processor configured to receive and interpret a command packet, a second processor connected to a nonvolatile memory device, and a memory device comprising a first memory bank and a second memory bank. The first processor writes a first unit of data to the first memory bank, and the first unit of data is subsequently programmed in the nonvolatile memory device under the control of the second processor through a buffered program operation using the second memory bank, or an un-buffered program operation not using the second memory bank, depending on a size of the first unit of data.

In certain embodiments, the first memory bank is a shared memory area shared by the first and second processors, and the second memory bank is a dedicated memory area dedicated to the second processor.

In certain embodiments, the memory device further comprises a semaphore register storing semaphore data for regulating access to the first memory bank.

In certain embodiments, the buffered program operation comprises an operation for writing the first unit of data from the first memory bank to the second memory bank, and a subsequent operation for accessing the first unit of data in the second memory bank and programming the first unit of data in the nonvolatile memory device.

In certain embodiments, the first processor transfers a second unit of data to the first memory bank while the first unit of data is accessed in the second memory bank for programming in the nonvolatile memory device.

In certain embodiments, the first unit of data is programmed in the nonvolatile memory device using the buffered program operation where the first unit of data is larger than a reference size.

In certain embodiments, the first and second processors, the memory device, and the nonvolatile memory device are incorporated in a memory card.

In certain embodiments, the first and second processors, the memory device, and the nonvolatile memory device are incorporated in a smart phone.

In certain embodiments, the memory device comprises a dynamic random access memory and the nonvolatile memory device comprises a flash memory.

According to still another embodiment of the inventive concept, a method of programming a nonvolatile memory device comprises receiving a command packet indicating the presence of a first unit of data in a shared memory area of a volatile memory device, and a size of the first unit of data, retrieving the first unit of data from the shared memory area in response to the command packet, programming the first unit of data in the nonvolatile memory device using a buffered program operation where the size of the first unit of data is greater than a reference value, and programming the first unit of data in the nonvolatile memory device using an un-buffered program operation where the size of the first unit of data is not greater than the reference value.

In certain embodiments, the method further comprises writing a second unit of data to the shared memory area during the buffered program operation.

### BRIEF DESCRIPTION OF THE DRAWINGS

Embodiments of the inventive concept are described below with reference to the corresponding drawings. In the drawings, like reference numbers denote like features.

FIG. 1 is a block diagram of a data processing system according to an embodiment of the inventive concept.

FIG. 2 illustrates an example of a command packet of FIG. 1.

FIG. 3 is a block diagram showing an embodiment of a multi-port memory device of FIG. 1.

FIG. 4 is a block diagram showing an embodiment of a second processor of FIG. 1.

FIG. 5 is a timing diagram of a buffered write operation of the data processing system of FIG. 1 according to an embodiment of the inventive concept.

FIG. 6 is a timing diagram of another buffered write operation of the data processing system of FIG. 1 according to an embodiment of the inventive concept.

FIG. 7 is a flowchart illustrating a method of performing a program operation in the data processing system of FIG. 1 according to an embodiment of the inventive concept.

### DETAILED DESCRIPTION OF THE EMBODIMENTS

Selected embodiments of the inventive concept are described below with reference to the accompanying drawings. These embodiments are presented as teaching examples and should not be interpreted to limit the scope of the inventive concept as defined by the claims.

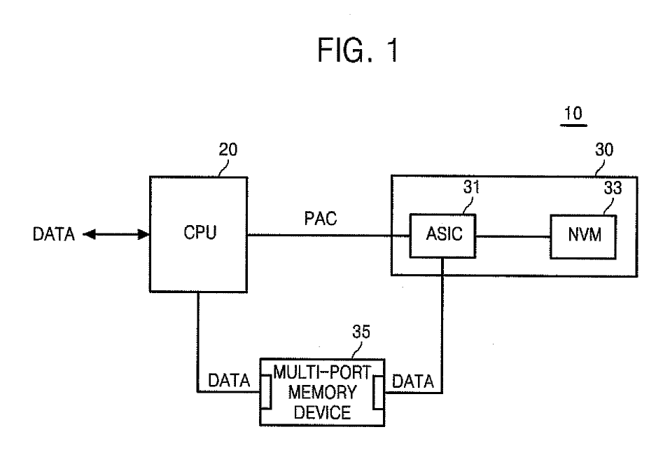

FIG. 1 is a block diagram of a data processing system 10 according to an embodiment of the inventive concept. Data processing system 10 is typically incorporated in an electronic device. For instance, in certain embodiments, data processing system 10 can by incorporated in a personal computer (PC), a memory card, a smart card, a mobile phone, a smart phone, a personal digital assistant (PDA), a portable media player (PMP), a digital still camera, or a solid state drive. Data processing system 10 can also be configured to operate as an embedded storage solution.

Referring to FIG. 1, data processing system 10 comprises a first processor 20, a memory device 30, and a multi-port memory device 35. Memory device 30 comprises a second processor (ASIC) 31 and a nonvolatile memory device (NVM) 33.

First processor 20 typically comprises a central processing unit (CPU). First processor 20 receives program data DATA, processes the program data to produce a command packet PAC, and transmits command packet PAC to second processor 31. In addition, first processor 20 transmits program data DATA to multi-port memory device 35.

First processor 20 generates command packet PAC based on an analysis of program data DATA. For instance, first processor 20 detects a size of program data DATA and determines whether to perform a buffered program operation or an un-buffered program operation based on the size. First processor 20 then generates command packet PAC with an indication of whether to perform the buffered program operation or an un-buffered program operation. The determination of whether to perform the buffered or un-buffered program operation is typically be made by comparing the size of program data DATA with a reference data size.

First processor 20 communicates with second processor 31 and multi-port memory device 35 using protocols based on the nature of those devices. For instance, where second processor 31 is formed in a secure digital (SD) card or a multi media card (MMC) protocol, first processor 20 can communicate with those devices using a SD protocol or a MMC protocol. Similarly, where multi-port memory device 35 comprises a dynamic random access memory (DRAM), first processor 20 can communicate with multi-port memory device 35 using a DRAM protocol.

Nonvolatile memory device 33 typically comprises one of several known types of nonvolatile memory. Examples of such memories include electrically erasable programmable read-only memory (EEPROM), flash memory, magnetic random access memory (MRAM), spin-transfer torque MRAM, conductive bridging RAM (CBRAM), ferroelectric RAM (FRAM), phase change RAM (PRAM), resistive RAM (RRAM), nanotube RRAM, polymer RAM (PoRAM), nano floating gate memory (NFGM), holographic memory, molecular electronics memory device, and insulator resistance change memory.

Multi-port memory device 35 typically comprises a shared memory area shared by first and second processors 20 and 31, and dedicated memory areas dedicated to respective first and second processors 20 and 31. Multi-port memory device 33 can be used to facilitate data transfer and communication between first processor 20 and memory device 30. Access to the shared memory area is typically regulated such that only one processor has access to the shared area at a time. For instance, in certain embodiments described below, access to a shared memory area is regulated by a semaphore.

In some embodiments, multi-port memory device 35 can be replaced with a single port memory device designed to perform similar functions.

Certain components of data processing system 10 can be configured to operate as a memory link architecture. For instance, a memory link architecture can be formed by second processor 31 and nonvolatile memory device 33, or second processor 31, nonvolatile memory device 33, and multi-port memory device 35. Also, in certain embodiments, one or more components of data processing system 10 are configured to operate as a memory card. For example, a memory card can be formed by second processor 31, nonvolatile memory device 33, and multi-port memory device 35.

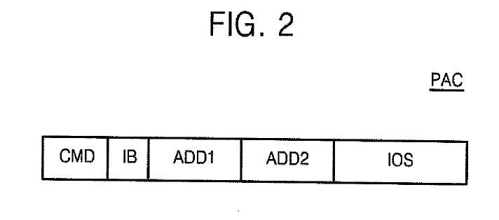

FIG. 2 illustrates an example of command packet PAC of FIG. 1. Referring to FIG. 2, command packet PAC comprises command information CMD, operation information IB, shared memory bank address ADD1, nonvolatile memory address ADD2, and size information IOS.

Command information CMD indicates the nature of a command corresponding to program data DATA. For instance, command information CMD is typically set to “1” to indicate a program command, and is typically set to “0” to indicate a read command.

Operation information IB indicates whether a program operation is to be performed as a buffered program operation or an un-buffered program operation. Where the program operation is to be performed as a buffered program operation, operation information IB is typically set to “1”. Otherwise, where the program operation is to be performed as an un-buffered program operation, operation information IB is typically set to “0”.

Shared memory bank address ADD1 indicates an address in multi-port memory device 35 where program data DATA is to be stored, and nonvolatile memory address ADD2 indicates an address in nonvolatile memory device 33 where program data DATA is to be stored.

Size information IOS indicates a size of program data DATA. The size of program data DATA is used to determine whether the program operation is performed as a buffered program operation or an un-buffered program operation.

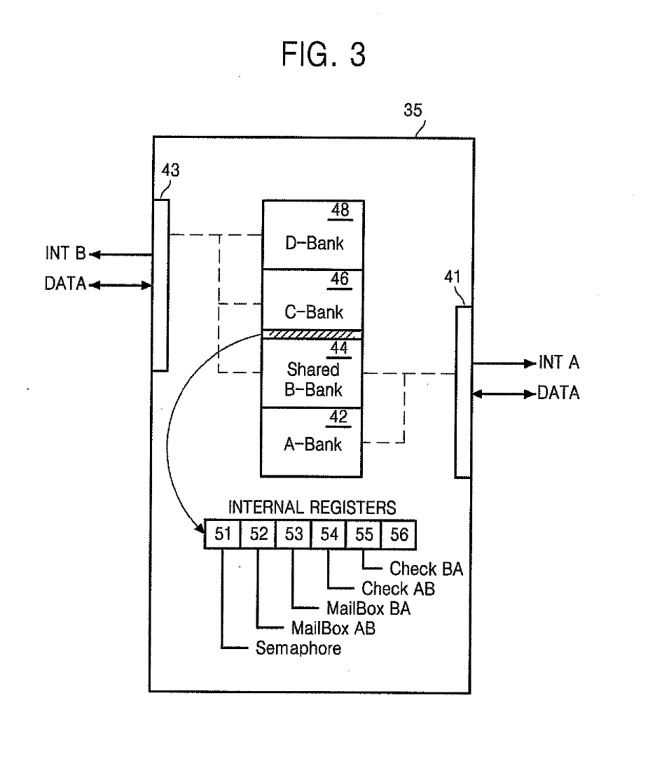

After command packet PAC is generated, first processor 20 transmits command packet PAC to second processor 31 and stores program data DATA at shared memory bank address ADD1 in a shared memory area of multi-port memory device 35 (e.g., shared memory bank 44 in FIG. 3). The shared memory area of multi-port memory device 35 is shared by first processor 20 and memory device 30. Accordingly, first processor 20 and memory device 30 must gain permission before accessing the shared memory area of multi-port memory device.

Second processor 31 receives and decodes command packet PAC and then accesses program data DATA at shared memory bank address ADD1 in the shared memory area of multi-port memory device 35 based on the decoded result.

Where operation information IB is “0”, second processor 31 stores program data DATA in nonvolatile memory device 33 using an un-buffered program operation. In the un-buffered program operation, second processor 31 retrieves program data DATA from shared memory bank address ADD1 in the shared memory area of multi-port memory device 35 and stores the retrieved data in nonvolatile memory device 33.

Where operation information IB is “1”, second processor 31 stores program data DATA in nonvolatile memory device 33 using a buffered program operation. In the buffered program operation, second processor 31 transfers or copies program data DATA from shared memory bank address ADD1 of the shared memory area of multi-port memory device 35 to a dedicated memory area of multi-port memory device 35 that is dedicated to second processor 31 (e.g., dedicated memory bank 42 of FIG. 3). Thereafter, second processor 31 transfers program data DATA from the dedicated area of multi-port memory device 35 to nonvolatile memory address ADD2 within nonvolatile memory device 33. To facilitate the transfer of program data DATA between the dedicated area of multi-port memory device 35 and nonvolatile memory address ADD2, second processor 31 or another element typically stores an address of the dedicated memory area where program data DATA is stored.

The buffered program operation can improve the overall performance of system 10 by allowing first processor 20 to transfer subsequent program data to the shared memory area of multi-port memory device 35 while program data DATA is stored in nonvolatile memory device 33. Without the buffered program operation, first processor 20 may be required to wait for access permission to the shared memory area, which can decrease performance.

FIG. 3 is a block diagram showing an embodiment of multi-port memory device 35 of FIG. 1. In this embodiment, multi-port memory device 35 comprises a first port 41, a plurality of memory banks 42, 44, 46, and 48, and a second port 43.

First port 41 exchanges data and/or control signals related to the data input/output with second processor 31. Thus, first port 41 constitutes an interface or a controller for exchanging data and/or control signals related to input/output of the data with second processor 31.

Second port 43 exchanges data and/or control signals related to data input/output with first processor 20. Thus, second port 43 constitutes an interface or a controller for exchanging data and/or control signals related to input/output of the data with first processor 20.

First and second ports 41 and 43 can be implemented by hardware comprising a plurality of logic circuits. They can also be implemented by a combination of hardware and software, such as firmware and an electronic storage medium.

Memory bank 42 is a dedicated memory bank that can be accessed by second processor 31 through first port 41, but cannot be accessed by first processor 20. Memory banks 46 and 48 are dedicated memory banks that can be accessed first processor 20 through second port 43, but cannot be accessed by second processor 31. Memory bank 44 is a shared memory bank that can be accessed by first processor 20 or second processor 31 according to an access authority regulated by a semaphore stored in a semaphore register 51. Program data DATA output from first processor 20 is stored in shared memory bank 44.

Shared memory bank 44 comprises internal registers 51-56. Internal registers 51-56 each typically have a size corresponding to one row of a memory. Each row can comprise, for instance 2 Kbytes. Registers 51-56 can be accessed using rows of shared memory bank 44, as indicated, for instance, by a shaded portion of FIG. 3. Addresses corresponding to internal registers 51-56 can be disabled for other processes but enabled for register access operations.

Internal registers 51-56 comprise a semaphore register 51, mail box registers 52 and 53, check registers 54 and 55, and a reserved register 56. Internal registers 51-56 prevent conflict situations from occurring when first processor 20 and second processor 31 simultaneously access shared memory bank 44. The conflicts are prevented by managing access authority and data between first and second processors 20 and 31. Internal registers 51-56 also provide messaging capabilities through registers 52-55 to allow communication between first and second processors 20 and 31.

Semaphore register 51 stores a bit indicating which port among first port 41 and second port 43 has access authority to shared memory bank 44. In other words, semaphore register 51 stores a bit indicating which of the processors 20 and 31 has access authority to shared memory bank 44. In one embodiment, a value “1” in semaphore register 51 indicates that first processor 20 has access authority to shared memory bank 44 through second port 43, and a value “0” in semaphore register 51 indicates that second processor 31 has access authority to shared memory bank 44 through first port 41. The value of the semaphore register 51 can be written only by processor 20 or 31 having access authority.

Mail box registers 52 and 53 store messages transmitted between first and second processors 20 and 31. To send a message from second processor 31 to first processor 20, second processor 31 writes a message in mail box register 52, and first processor 20 subsequently reads the message from mail box register 52. Conversely, to send a message from first processor 20 to second processor 31, first processor 20 writes a message in mail box register 53, and second processor 31 subsequently reads the message from mail box register 53.

Where a message is written to mail box register 53, an interrupt signal INT A is generated, and where a message is written to mail box register 52, an interrupt signal INT B is generated. Interrupt signal INT A is transmitted to second processor 31 via first port 41 and interrupt signal INT B is transmitted to first processor via port 43.

Check registers 54 and 55 store values indicating whether messages written to respective mail box registers 52 and 53 have been read through a corresponding port. For example, where second processor 31 stores a message in mail box register 52, the value of check register 54 is set to “1”, and where first processor 20 reads the message from mail box register 52, the value of check register 54 is set to “0”.

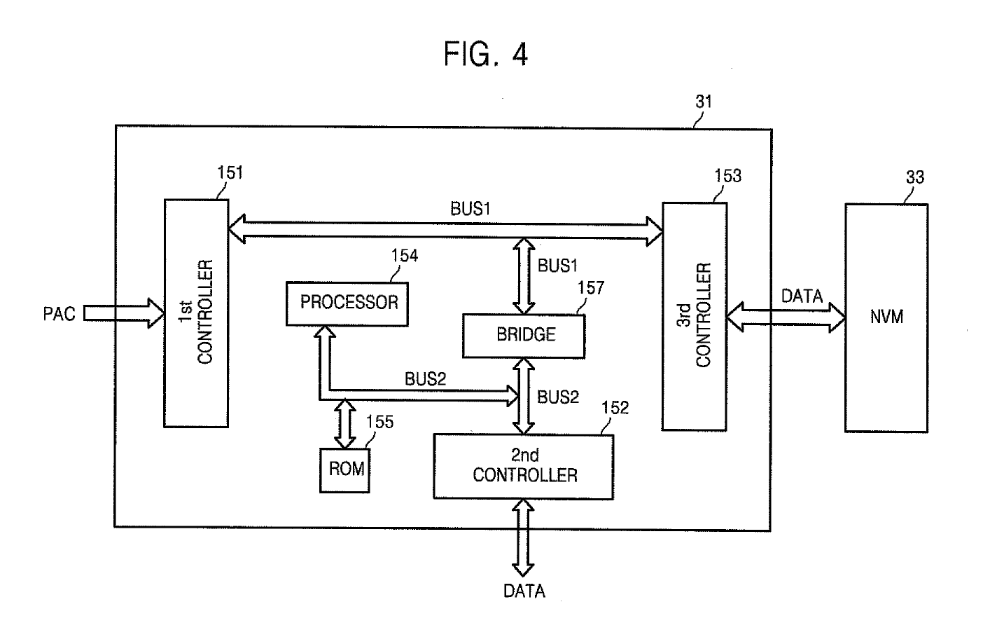

FIG. 4 is a block diagram showing an embodiment of second processor 31 of FIG. 1. In the embodiment of FIG. 4, second processor 31 is an application-specific integrated circuit (ASIC). Second processor 31 comprises a plurality of controllers 151, 152, and 153, a processor 154, a bridge 157, a ROM 155, and a plurality of buses BUS1 and BUS2.

First controller 151 provides an interface for data exchange between second processor 31 and first processor 20. First controller receives command packet PAC output by first processor 20 and outputs command packet PAC to bridge 157 via bus BUS1. In certain embodiments, first controller 151 comprises an interface supporting an SD card protocol or an MMC protocol. In such embodiments, first controller 151 exchanges signals with first processor 20 using the SD card or MMC protocol.

Second controller 152 provides an interface for data exchange between second processor 31 and first port 41 of multi-port memory device 35. In certain embodiments, second controller 152 comprises an interface supporting a DRAM protocol. In such embodiments, second controller 152 exchanges signals with multi-port memory device 35 according to the DRAM protocol.

Third controller 153 provides an interface for exchanging data between second processor 31 and nonvolatile memory device 33. In certain embodiments, third controller 153 comprises an interface supporting a NAND flash memory protocol. In such embodiments, third controller 153 exchanges signals with nonvolatile memory device 33 using the NAND flash memory protocol.

Processor 154 loads and executes a program stored in ROM 155. In certain embodiments, the program comprises program codes for controlling the buffered and un-buffered program operations described above. Processor 154 also interprets command packet PAC output from first processor 20 and controls the operation of controllers 151, 152, or 153 according to a result of the interpretation.

To perform the un-buffered program operation, processor 154 controls second controller 152 to read program data DATA from memory bank 44, and controls third controller 153 to store program data DATA in nonvolatile memory device 33. These operations are initiated and controlled based on information in command packet PAC, which is received by processor 154 through first controller 151 and bridge 157.

To perform the buffered program operation, processor 154 controls second controller 152 to copy or transfer program data DATA from shared memory bank 44 to dedicated memory bank 42, and then subsequently controls second controller 152 to transfer program data DATA from dedicated memory 42 to third controller 153 for programming in nonvolatile memory device 33. Processor 154 then controls third controller 153 to store program data DATA in nonvolatile memory device 33. These operations are initiated and controlled based on information in command packet PAC, which is received by processor 154 through first controller 151 and bridge 157. The process of storing program data DATA in dedicated memory 42 for subsequent programming in nonvolatile memory device 33 constitutes a data buffering operation.

Bridge 157 converts protocols for data exchanged between buses BUS1 and BUS2 and/or control signals related to the transmission of the data.

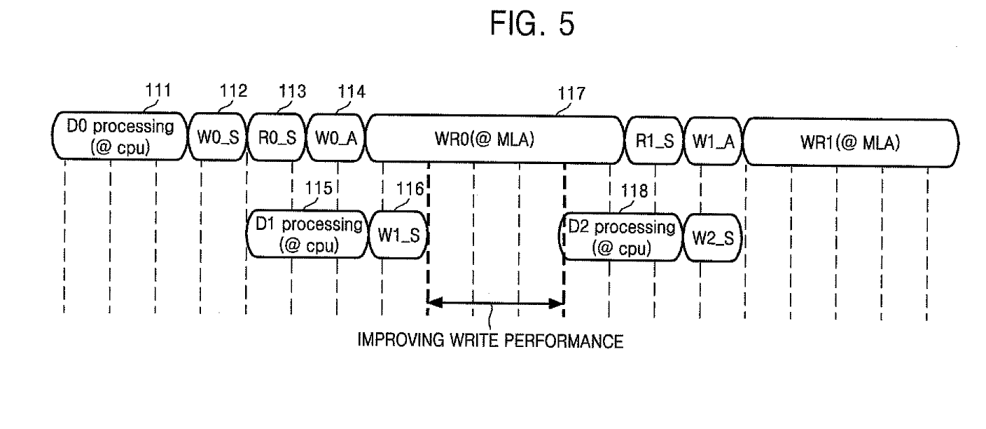

FIG. 5 is a timing diagram of a buffered write operation of data processing system 10 of FIG. 1. Referring to FIG. 5, in the buffered write operation, first processor 20 receives and processes first program data D0 and generates command packet PAC (111). First processor 20 then transfers command packet PAC to second processor 31.

First processor 20 acquires access authority for shared memory bank 44 and writes first program data D0 to shared memory bank 44 (112). First processor 20 also writes a message in mail box register 53 to indicate the presence of first program data D0 in shared memory bank 44, and multi-port memory device 35 generates interrupt signal INT A and transmits interrupt signal INT A to second processor 31 via first port 41.

Second processor 31 receives command packet PAC from first processor 20 and interprets command packet PAC to detect that a buffered program operation is to be performed. Second processor 31 subsequently acquires access authority to shared memory bank 44 in response to command packet PAC and interrupt signal INT A. After receiving access authority to shared memory bank 44, second processor 31 reads first program data D0 from shared memory bank 44 (113).

Second processor 31 copies or transfers first program data D0 read from shared memory bank 44 to dedicated memory bank 42 according to the interpreted command packet PAC (114). During operations 113 and 114, first processor 20 receives and processes second program data D1 and generates another command packet PAC based on second program data D1 (115). While second processor 31 reads first program data D0 from dedicated memory bank 42 according to the initial command packet PAC and writes first program data D0 to nonvolatile memory device 33 (117), first processor 20 acquires access authority to shared memory bank 44 and writes second program data D1 to shared memory bank 44 of multi-port memory device 35 (116). During operation 117, first processor 20 receives and processes third program data D2 and generates yet another command packet PAC based on third program data D2 (118).

Thus, data processing system 10 simultaneously performs operations 116 and 117. Also, data processing system 10 can perform operation 117 between a time point where operation 116 is completed and a time point where operation 118 starts, which can improve write performance.

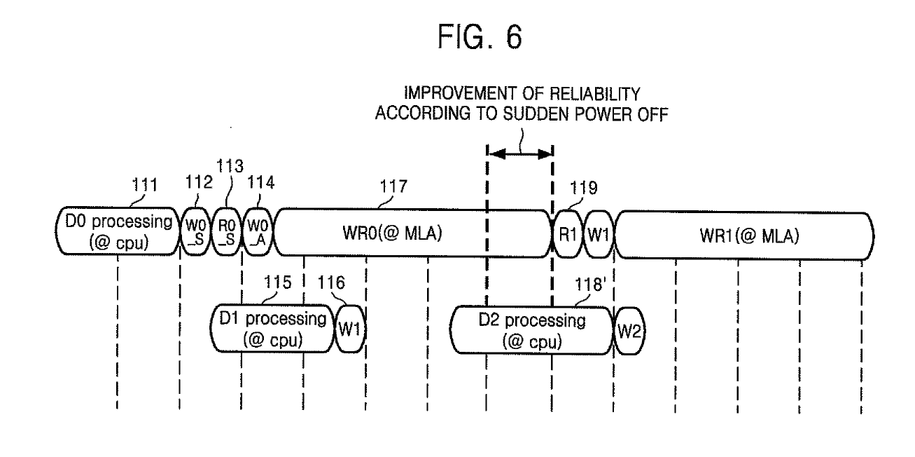

FIG. 6 is a timing diagram of another buffered program operation of data processing system 10 of FIG. 1. The example of FIG. 6 is similar to that of FIG. 5, except that in the example of FIG. 6, second processor 31 having access authority to shared memory bank 44 both reads and copies second program data D1 from shared memory bank 44 after operation 117 is completed and before first processor 20 writes third data D2 to shared memory bank 44. This is accomplished by shifting the timing of operation 118 to operation 118′ shown in FIG. 6. By making this change, the reliability of stored data is improved in the presence of a sudden loss of power.

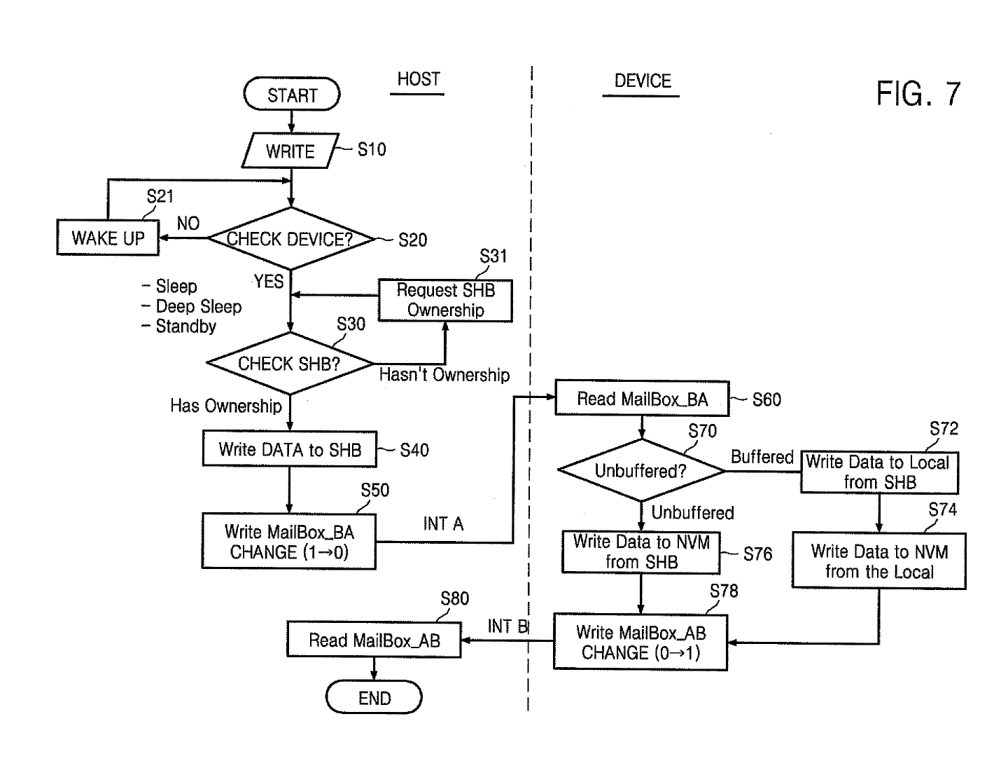

FIG. 7 is a flowchart illustrating a method of performing a program operation in the data processing system of FIG. 1 according to an embodiment of the inventive concept. Referring to FIGS. 1-7, first processor 20 determines whether an externally input command is a write command (S10). Then, first processor 20 checks a state of memory device 30 (S20). Where the state of memory device 30 is in a sleep state, a deep sleep state, or a standby state (S20=No), first processor 20 wakes up memory device 30 (S21).

Otherwise (S20=Yes), first processor 20 determines whether it has access authority or ownership of to shared memory bank (SHB) 44 of multi-port memory device 35 (S30). For example, first processor 20 may determine the existence of access authority by reading the bit stored in the semaphore register 51. Where second processor 31 has access authority to shared memory bank 44 (S30=Hasn't Ownership), first processor 20 requests a change of access authority to shared memory bank 44 (S31). This can be accomplished, for instance, by placing a message in mail box register 53.

Where first processor 20 has access authority to shared memory bank 44 (S30=Has Ownership), first processor 20 generates a command packet PAC corresponding to a result of comparing a size of program data DATA and a reference size and transmits the generated command packet PAC to second processor 31. First processor 20 writes program data DATA in shared memory bank 44 using control signals (S40).

To inform second processor 31 of program data DATA being written in shared memory bank 44, first processor 20 writes a message to mail box register 53 and changes the bit of semaphore register 51 from “1” to “0” (S50). Where the message is written to mail box register 53, interrupt signal INT A is activated and transmitted to second processor 31 via first port 41.

Second processor 31 reads the message written to mail box register 53 in response to activated interrupt signal INT A (S60). Thus, second processor 31 recognizes based on the read message that the access authority to shared memory bank 44 is changed. Second processor 31 interprets operation information IB included in the received command packet PAC and recognizes whether to perform a buffered write operation or an un-buffered program operation according to a result of interpretation (S70).

Where second processor 31 performs the buffered write operation (S72=Buffered), second processor 31 reads the data written to shared memory bank 44 according to shared memory bank address ADD1, writes the read data to shared memory bank 44 (S72), and writes the data written to shared memory bank 44 to nonvolatile memory device 33 according to nonvolatile memory address ADD2 (S74).

Where second processor 31 performs the un-buffered program operation (S72=Unbuffered), second processor 31 reads the data written to shared memory bank 44 according to shared memory bank address ADD1, and writes the data to nonvolatile memory device 33 according to nonvolatile memory address ADD2 (S76).

After the buffered write operation or the un-buffered program operation is completed second processor 31 writes a message to the mail box register 52 and changes the bit of the semaphore register 51 from “0” to “1” to inform first processor 20 of the completion of the write operation (S78). Where the message is written to the mail box register 52, interrupt signal INT B that is activated is transmitted to first processor 20 via second port 43.

First processor 20, in response to the activated interrupt signal INT B, reads the message written to the mail box register 52 (S80). Thus, first processor 20 recognizes the change of access authority to shared memory bank 44 based on the read message.

Although the embodiments described with reference to FIGS. 1-7 relate to program operations, certain principles of the embodiments can be applied to read operations as well. For example, in one embodiment, first processor 20 generates a command packet according to the size of data to be read and the size of reference data. The command packet for a read operation is substantially the same as the command packet of FIG. 2. Second processor 31 then reads data from nonvolatile memory device 33 according to the command packet and writes the data to shared memory bank 44 of multi-port memory device 35. Thus, first processor 20 reads the data stored in shared memory bank 44 during the un-buffered read operation and reads the data stored in any one of dedicated memory banks 46 and 48 during the buffered read operation.

During the buffered read operation, first processor 20 copies or writes the data stored in shared memory bank 44 to any one of dedicated memory banks 46 and 48.

As indicated by the foregoing, the above methods and systems allow data to be stored or retrieved using buffered or un-buffered operations based on the size of data. These methods and systems can improve read and write performance.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of operating a data processing system comprising first and second processors and first and second memory devices, the method comprising:
transmitting a first command packet from the first processor to the second processor, the first command packet corresponding to a first program operation for programming a first unit of data in the second memory device;
detecting a size of the first unit of data by inspecting the command packet and determining whether the size of the first unit of data is greater than a reference value;
upon determining that the size of the first unit of data is greater than the reference value, copying the first unit of data from a shared memory area of the first memory device to a dedicated memory area of the first memory device, and subsequently accessing the first unit of data in the dedicated memory area for programming in the second memory device, wherein the shared memory area is shared by the first and second processors, and the dedicated memory area is dedicated to the second processor; and
upon detecting that the size of the first unit of data is not greater than the reference value, transferring the first unit of data from the shared memory area to the second processor for programming in the second memory device.

2. The method of claim 1, further comprising:
transmitting a second command packet from the first processor to the second processor, the second command packet corresponding to a second program operation for programming a second unit of data in the second memory device; and
storing the second unit of data in the shared memory area of the first memory device while the first unit of data is accessed in the dedicated memory area of the first memory device by the second processor.

3. The method of claim 1, wherein access to the shared memory area of the first memory device is controlled such that only one of the first and second processors can access the shared memory at a time.

4. The method of claim 3, wherein access to the shared memory area of the first memory device is regulated using a semaphore.

5. The method of claim 1, wherein the first memory device is a volatile memory device and the second memory device is a nonvolatile memory device.

6. The method of claim 5, wherein the first memory device is a dynamic random access memory and the second memory device is a flash memory device.

7. The method of claim 1, wherein the first memory device is a multi-port memory device.

8. The method of claim 1, wherein the second processor is an application specific integrated circuit.

9. The method of claim 1, wherein the first memory device, the second memory device, and the second processor form a memory link architecture.

10. A data processing system comprising:
a first processor configured to receive and interpret a command packet;
a second processor connected to a nonvolatile memory device; and
a memory device comprising a first memory bank and a second memory bank;
wherein the first processor writes a first unit of data to the first memory bank, and the first unit of data is subsequently programmed in the nonvolatile memory device under the control of the second processor through a buffered program operation using the second memory bank, or an un-buffered program operation not using the second memory bank, depending on a size of the first unit of data.

11. The data processing system of claim 10, wherein the first memory bank is a shared memory area shared by the first and second processors, and the second memory bank is a dedicated memory area dedicated to the second processor.

12. The data processing system of claim 10, wherein the memory device further comprises a semaphore register storing semaphore data for regulating access to the first memory bank.

13. The data processing system of claim 10, wherein the buffered program operation comprises an operation for writing the first unit of data from the first memory bank to the second memory bank, and a subsequent operation for accessing the first unit of data in the second memory bank and programming the first unit of data in the nonvolatile memory device.

14. The data processing system of claim 13, wherein the first processor transfers a second unit of data to the first memory bank while the first unit of data is accessed in the second memory bank for programming in the nonvolatile memory device.

15. The data processing system of claim 10, wherein the first unit of data is programmed in the nonvolatile memory device using the buffered program operation where the first unit of data is larger than a reference size.

16. The data processing system of claim 10, wherein the first and second processors, the memory device, and the nonvolatile memory device are incorporated in a memory card.

17. The data processing system of claim 10, wherein the first and second processors, the memory device, and the nonvolatile memory device are incorporated in a smart phone.

18. The data processing system of claim 10, wherein the memory device comprises a dynamic random access memory and the nonvolatile memory device comprises a flash memory.

19. A method of programming a nonvolatile memory device, comprising:
receiving a command packet indicating the presence of a first unit of data in a shared memory area of a volatile memory device, and a size of the first unit of data;
retrieving the first unit of data from the shared memory area in response to the command packet;
programming the first unit of data in the nonvolatile memory device using a buffered program operation where the size of the first unit of data is greater than a reference value; and
programming the first unit of data in the nonvolatile memory device using an un-buffered program operation where the size of the first unit of data is not greater than the reference value.

20. The method of claim 19, further comprising:
writing a second unit of data to the shared memory area during the buffered program operation.
